(19) United States
(12) Patent Application Publication
(10) Pub. No.: US 2007/0253199 A1
(43) Pub. Date: Nov. 1, 2007

(54) Vandal Resistant Luminaire

(75) Inventors: Kenneth W. Biello, Stroudsbourg, PA (US); Dylan A. Akinrele, Leonia, NJ (US); David S. Monteiro, Belleville, NJ (US); Thomas Russello, Freehold, NJ (US)

Correspondence Address: MIDDLETON & REUTLINGER, 2500 BROWN & WILLIAMSON TOWER, LOUISVILLE, KY, 40202, US

(73) Assignee: GENLYTE THOMAS GROUP LLC, Louisville, KY (US)

(21) Appl. No.: 11/741,293

(22) Filed: Apr. 27, 2007

Related U.S. Application Data
(60) Provisional application No. 60/745,920, filed on Apr. 28, 2006.

(51) Int. Cl. F21V 29/00

(52) U.S. Cl. 362/267; 362/158

(57) ABSTRACT

A vandal resistant luminaire having an electrical component housing with an outwardly extending rim separating a front portion from a rear portion; the front portion has a gasket ring about a front edge, at least one lamp socket, wiring, and associated electrical components contained therein; a shock absorbing gasket is mounted on the gasket ring and a lens with a rear edge removeably sealed against the gasket by means of a front trim ring that surrounds an outer portion of the lens and an outer portion of the front portion of the electrical component housing. Optionally, the vandal resistant luminaire has a rear trim ring surrounding a rear portion of the electrical component housing having a shock absorbing configuration and a substantially flat rear mating surface eliminating pry points between the vandal resistant luminaire and a surface too which it is mounted. Additionally, the front trim ring may depend about the lens forming a pattern thereon such as a grid pattern or a graphical display area.

### CROSS-REFERENCE TO RELATED APPLICATIONS

This application under 35 USC § 119(e) claims priority to, and benefit from, U.S. Provisional Application Ser. No. 60/745,920, filed on Apr. 28, 2006, entitled “Vandal Resistant Luminaire,” which is currently pending, naming the above-listed individuals as joint inventors.

### STATEMENT REGARDING FEDERALLY SPONSORED RESEARCH OR DEVELOPMENT

Not applicable.

### FIELD OF INVENTION

The present invention relates to luminaires or more specifically an aesthetic and physical shock absorbing vandal resistant luminarie.

### BACKGROUND OF THE INVENTION

Many existing public locations, both indoor and outdoor, have luminaires installed. Even though these luminaires are intended to benefit the public they are often times an annoyance for a would be vandal or thief. Therefore, luminaires have long have been targeted for disablement or destruction by vandals, thieves, and others seeking to reduce the amount of light present in a given locale. Luminaire electrical component housings and lamps contained within the electrical component housings of such luminaires are typically too fragile in construction. Physical impact or even mere jarring can disable a luminaire or even destroy a portion thereof. The damage can occur to the electrical component housing, lamp, lens, or other component thereby extinguishing the light emitted by the luminaire. Attempts have been made to address this problem for those seeking to maintain the functional status of a luminaire in a public place. This has been addressed by constructing armored luminaires which have an armored electrical component housing or by placing the luminaire out of reach to the public. However, the armor has tended to make the luminaire less aesthetic than desired and the locating of the luminaires out of reach often times decreases the ability of the luminaire to light a desired area. More recently, vandal resistant luminaires have been constructed with plastics, however the configuration of such luminaires has often times failed to provide adequate resistance to tampering.

Thus a need continues to exist for luminaires to resist the attempts of vandals, would-be thieves, and the like from destroying the luminaire or extinguishing the light emitted thereby while providing adequate light and a more aesthetic vandal resistant luminaire.

### SUMMARY OF THE INVENTION

The present invention relates to a vandal resistant luminaire intended for use in public areas and designed to resist physical damage from impact, prying, or other physical force, while providing adequate light and an aesthetic luminaire. The luminaire is designed to absorb physical shock placed on the luminaire; protect any electrical components in a housing from impact; eliminate perimeter pry or holding points about the luminaire and between the luminaire and a mounting surface; and provide for an aesthetically pleasing vandal resistant luminaire with an optional graphical display area.

The vandal resistant luminaire preferably has an optional rear trim ring surrounding a rear portion of an electrical component housing wherein the electrical component housing has a lamp holder assembly, ballast, wiring, or other associated electrical components. The lamp holder assembly preferably has a reflective front surface and at least one lamp socket thereon. The electrical component housing has an outwardly extending rim separating the rear portion from the front portion where the front portion has a front trim ring engaged thereto holding a lens adjacent an optional gasket and the rear portion is optionally surrounded by the rear trim ring.

The optional rear trim ring is preferably comprised of a polycarbonate material and more preferably an ultraviolet stabilized polycarbonate material. The preferred method of manufacture is injection molding. The rear trim ring preferably has a substantially cylindrical configured side wall, optionally frustoconical, tapered, or curved, with housing contact projections, mating extensions, and indentations with adhesive strips proximate a top opening for mating to an outwardly extending rim on the electrical component housing creating an aesthetic substantially seamless outer surface while eliminating perimeter pry or holding points about the luminaire and between the luminaire and a mounting surface. The internal surface optionally has reinforcing ribs. The side wall is optionally tapered with a larger opening adjacent the surface to which it is mounted while the electrical component housing optionally has a tapered side wall with a smaller diameter proximate the surface to which it is mounted. Such configurations create an annular space between the rear trim ring and electrical housing where contact between the two components is proximate the front opening of the rear trim ring and the housing contact projections. This annular space provides room for deformation of the rear trim ring thus enabling the rear trim ring to absorb physical shock prior to impact of the luminaire housing. Optionally this annular space is filled with foam, preferably high density foam, neoprene rubber, or other shock absorbing material increasing the shock absorbing capacity of the rear trim ring and luminaire.

Preferably the front trim ring is comprised of a polycarbonate material and more preferably an ultraviolet stabilized polycarbonate material. The preferred method of manufacture is injection molding. The front trim ring preferably has a bezel configuration with a twist locking device for retaining the lens to the electrical component housing creating an aesthetic seamless outer surface while eliminating pry points between the housing and lens. The internal surface is configured for retaining the lens snugly against the optional gasket on the housing creating a seal there between. Optionally, a front face covering a portion of or forming a design on the lens may be incorporated into the trim ring. Alternatively, a front face covering may provide a graphical display area about the lens or other design.

Between the front trim ring and rear trim ring is an outwardly extending housing rim. This rim is visible between and substantially flush with the front and rear trim rings. The housing rim may incorporate accent colors providing improved aesthetics for the vandal resistant luminaire.

Preferably the gasket is comprised of extra thick extruded silicon rubber having a cross-sectional configuration that absorbs physical shock from lens impact while sealing against dust, moisture, and water. The cross-sectional configuration is such that it provides a seal between the lens and housing and absorbs physical shock placed on the lens.

### BRIEF DESCRIPTION OF THE DRAWINGS

FIG. 1 is a perspective view of a vandal resistant luminaire showing external components and cooperation thereof;

FIG. 2 is an exploded view of the vandal resistant luminaire of FIG. 1 showing the internal components and the cooperation thereof;

FIG. 3 is a perspective view of the front trim ring of FIG. 1 showing the internal structure for engaging a housing and lens;

FIG. 4 is a perspective view of an electrical component housing for a vandal resistant luminaire having a gasket placed about a front rim;

FIG. 5A is a cross-sectional view of an embodiment of a gasket for a vandal resistant luminaire in an expanded configuration;

FIG. 5B is a cross-sectional view of the gasket of FIG. 5A in a compressed configuration;

FIG. 6 is a top perspective view of the rear trim ring of FIG. 1;

FIG. 7 is a perspective view of an alternative embodiment of a front trim ring showing an open eyelid cover having a graphical display area; and

FIG. 8 is a perspective view of yet another embodiment of a front trim ring showing a grid about a lens.

### DETAILED DESCRIPTION

The present invention relates to a vandal resistant luminaire intended for use in a public area and designed to resist physical damage from impact while providing adequate light and an aesthetic luminaire. The luminaire depicted in the various figures is selected solely for the purpose of illustrating the invention. Other and different vandal resistant luminaires may utilize the inventive features described herein. Reference to the Figures showing embodiments are made only for descriptive purposes and are not intended to limit the scope of the claims and disclosure herein.

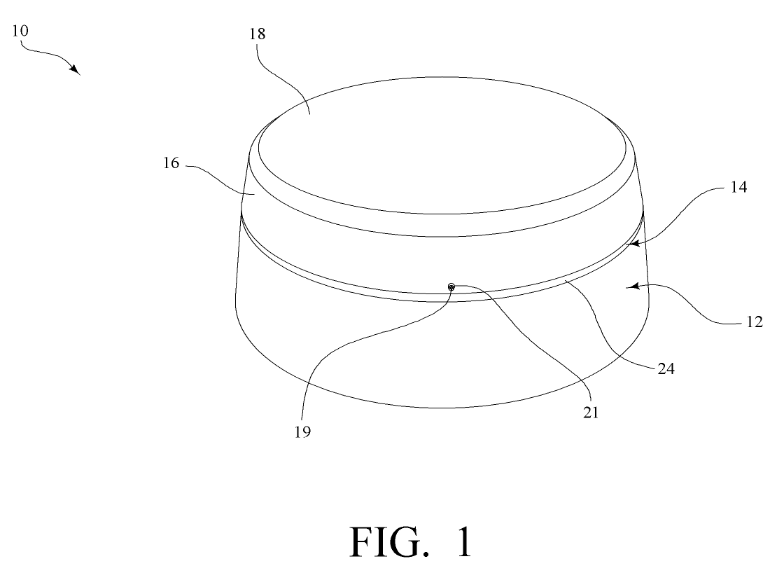

FIG. 1 shows the external components of vandal resistant luminaire 10. Rear trim ring 12 covers a portion of electrical component housing 14 providing an aesthetically pleasing rear side of luminaire 10 while increasing security of luminaire 10 by providing a substantially smooth outer side surface mounting flush against a wall or ceiling reducing perimeter pry or holding points about luminaire 10 and electrical component housing 14 and a mounting surface to which it is mounted. Electrical component housing 14 has an outwardly extending rim 24 visible in fully assembled luminaire 10 between rear trim ring 12 and front trim ring 16. Outwardly extending rim 24 may be colored or customized prior to assembly of luminaire 10 providing an economical luminaire accent ring. Front trim ring 16 surrounds an outer portion of lens 18 and electrical component housing 14 and locks onto electrical component housing 14 and is held in a locked position with locking fastener 19 extending through locking fastener receptacle 21 in front trim ring 16. Front trim ring 16 preferably has an outer bezel configuration providing a smooth outer surface for vandal resistant luminaire 10. Rear trim ring 12 surrounds a rear portion of electrical component housing 14 providing a smooth outer surface for vandal resistant luminaire 10. Rear trim ring 12 and front trim ring 16 preferably have a polycarbonate material, an ultraviolet stabilized material, or both and are preferably formed by an injection mold process. Rear trim ring 12 has a substantially flat edge for mounting flush against a wall or ceiling eliminating pry points between luminaire 10 and the surface to which it is mounted. The front edge of rear trim ring 12 mounts adjacent rim 24 substantially eliminating holding points about luminaire 10.

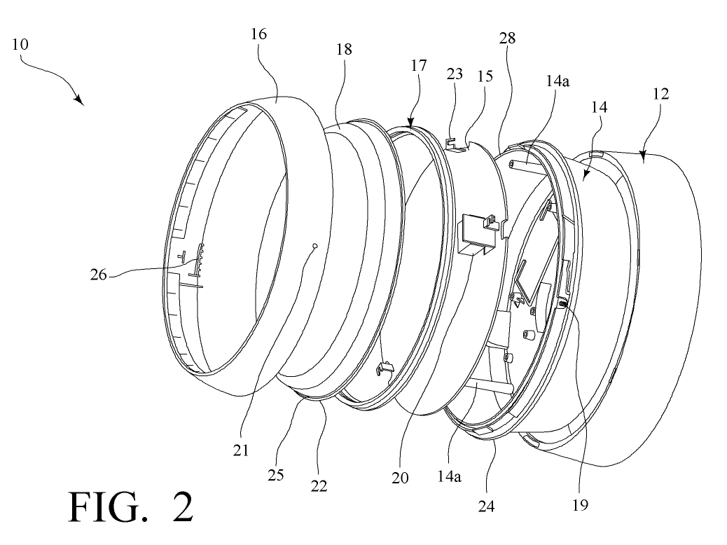

FIG. 2 shows the internal components of vandal resistant luminaire 10 and the placement and cooperation of components therein. Rear trim ring 12 is removed from electrical component housing 14 showing the outer configuration of electrical component housing 14 and cooperation between rear trim ring 12, outer rim 24 of electrical component housing 14, and front trim ring 16. Lamp holder assembly 15 attaches within electrical component housing 14 and has lamp socket 20 on a front surface. The front surface of lamp holder 15 is preferably comprised of a reflective material. Front trim ring 16 holds lens 18 to electrical component housing 14 with gasket 17 there between providing a substantially smooth outer front surface for vandal resistant luminaire 10. Gasket 17 is placed about gasket ring 28, both of which are optional and are shown having a continuously round configuration. Front trim ring 16 has twist locks 26 with sloping surfaces for securing about electrical component housing 14 and locking thereto with locking fastener 19 extending into locking fastener receptacle 21 in front trim ring 16. Lens 18 has outer lip 22 that cooperates with front trim ring 16 on a front surface and gasket 17 on a rear surface.

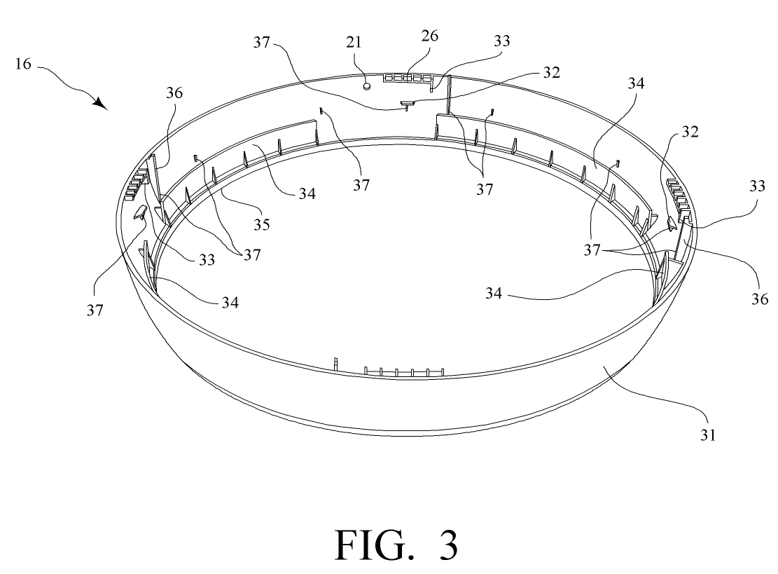

FIG. 3 shows the internal structure of front trim ring 16 and a means for cooperation with electrical component housing 14 and lens 18. Front trim ring 16 has a shock absorbing bezel configuration. In this embodiment, the shock absorbing configuration includes lens contact projections 37 extending inwardly from and spaced about the internal surface of front trim ring 16. Contact projections 37 contact the outer edge of outer lip 22 of lens 18 and provide a space between the inner side of bezel configured wall 31 and lens 18. Lock guides 36 depend from side wall 31 of front trim ring 16 and have a portion projecting beyond the side wall 31. In the embodiment shown, lens contact projections 37 have unitary lock guides 36. The space between front trim ring 16 and lens 18 improves the shock absorbing capacity of luminaire 10 by allowing front trim ring 16 to deform prior to the contact between inner wall of outer bezel configured wall 31 and lens 18. This deformation of trim ring 16 absorbs energy of a shock placed thereon prior to side impact with lens 18 thus reducing the shock thereto. Twist locks 26 have a substantially flat sloping surface for securing about electrical component housing 14. Twist stops 33 depend from the sloping surface of twist locks 26 providing an on stop functionality. Lens retainers 34, shown in the form of a series of annular flanges in this embodiment, depend from proximate a front opening toward twist locks 26. Lens retainers 34 have outer edges that cooperate with a slot 25 in the rear side of outer flange or lip 22 of lens 18. Lens retaining tabs 32 cooperate with the front edge of outer lip 22 holding lens 18 proximate lens retainers 34. A portion of lens contact projections 37 are shown extending from lens retaining tabs 32 and others are shown spaced about the inner surface of side wall 31. Locking fastener aperture 21 aligns with a locking fastener 19 in electrical component housing 14 when front trim ring 16 is fully engaged with electrical component housing 14.

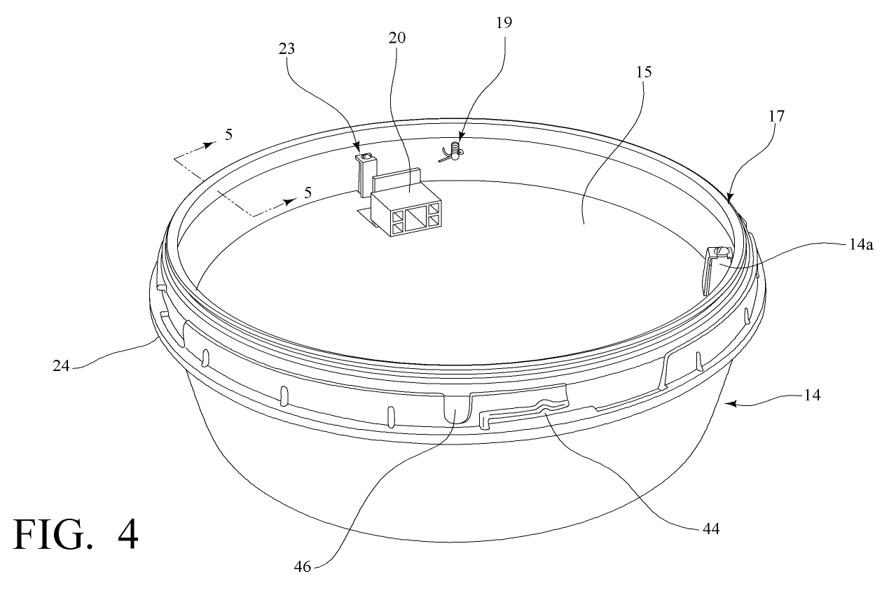

FIG. 4 shows electrical component housing 14 having gasket 17 attached to gasket ring 28 (FIG. 2). Within electrical component housing 14 is lamp holder assembly 15 having lamp socket 20. Preferably, the outer surface of lamp holder assembly 15 is comprised of a reflective material and is attached to pillars 14a extending from electrical component housing 14 by means of bracket and fastener combinations 23. The electrical wiring, ballast(s), if needed, and other associated electrical components of luminaire 10 are contained within electrical component housing 14 behind lamp holder assembly 15. On the outer rim of electrical component housing 14 above outer rim 24 are lug receptacles 44 (FIG. 4) for receiving locking lugs 26 on front trim ring 16. Locking fastener 19 is shown between outer rim 24 and gasket 17 on electrical component housing 14 for locking front trim ring 16 onto electrical component housing 14 by extending into fastener receptacle 21 (FIG. 3).

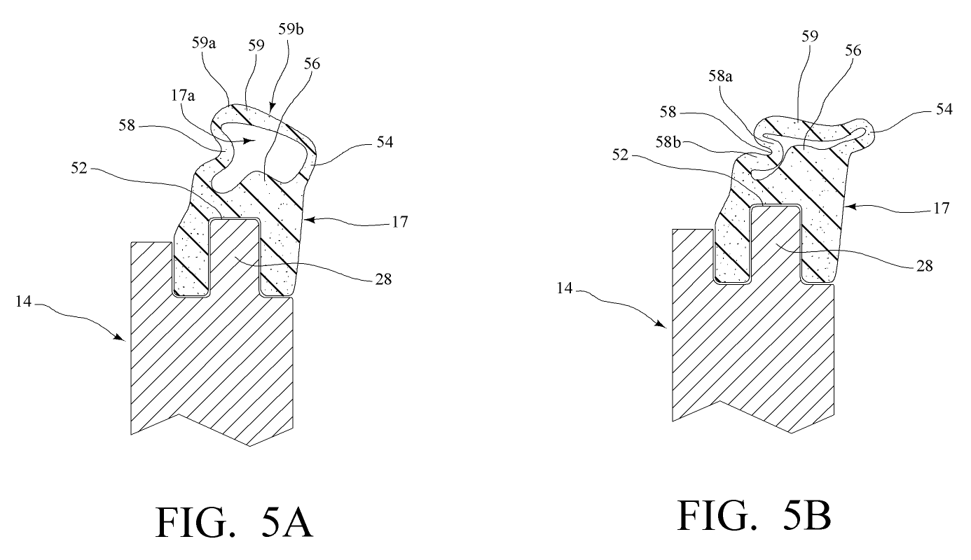

FIGS. 5A and 5B show a cross-sectional view of an embodiment of gasket 17 in an expanded and compressed configuration respectively. Gasket 17 is placed on gasket ring 28 by having gasket ring receiving notch 52 receiving gasket ring 28. Gasket 17 has a hollow interior 17a and a raised portion in lower wall 56 for absorbing physical shock. Inner wall 54 is convex or depends slightly outward to top wall 59. Top wall 59 is shown as being angled upward toward outer wall 58 providing a sealing surface 59a toward an outer portion of luminaire 10 for sealing with lens 18. Top wall 59 also has a thickened shock absorbing region 59b. Outer wall 58 is convex or depends inward so that when a force is placed on top wall 59 outer wall 58 folds inward as seen in FIG. 5B, providing shock absorbing material between electrical component housing 14 and lens 18. FIG. 5B shows the gasket of FIG. 5A in a compressed configuration. In this configuration outer wall 58 is folded inward to absorb the shock of lens 18 against gasket 17 providing layers of gasket material 58a and 58b between electrical component housing 14 and lens 18. This inward collapsing wall provides gasket 17 with additional shock absorbing capacity when a physical shock is placed on top wall 59. Additionally, the hollow center 17a in gasket 17 in this embodiment provides shock absorbing capacity with an increase in air pressure in the hollow center 17a when gasket 17 is compressed.

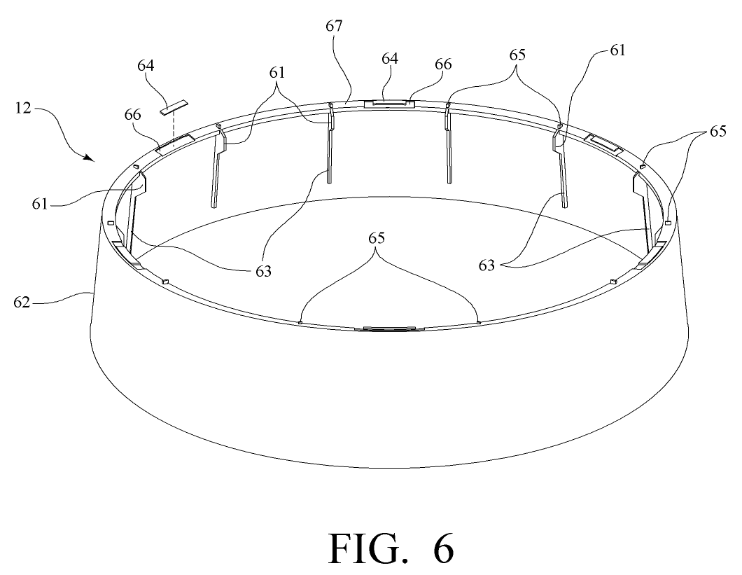

FIG. 6 shows a top view of rear trim ring 12 having optional adhesive strip 64 removed there from. Side wall 62 is shown here as having a frustoconical configuration with the rear opening having a larger radius than the front opening. Side wall 62 may be axially curved, substantially cylindrical, frustoconical, or other configuration. Optional reinforcing ribs 63, electrical component housing projections 61, and housing mating extensions 65 extending inward from side wall 62 are unitary structures as shown or may be individual components spaced about the inner circumferential surface of side wall 62. Proximate the front opening of rear trim ring 12 is an inwardly extending flange 67 which is shown in this embodiment as sloping downward. Extending from a front surface of flange 67 are housing mating extensions 65. Extending flange 67 has a series of indentations 66 in a front surface thereof for holding adhesive strips 64. Extending flange 67, indentations 66, and adhesive strips 64 are all optional components since rear trim ring 12 can provide a shock absorbing structure mounted between outwardly extending rim 24 on electrical component housing 14 and a mounting surface without any or all of these features.

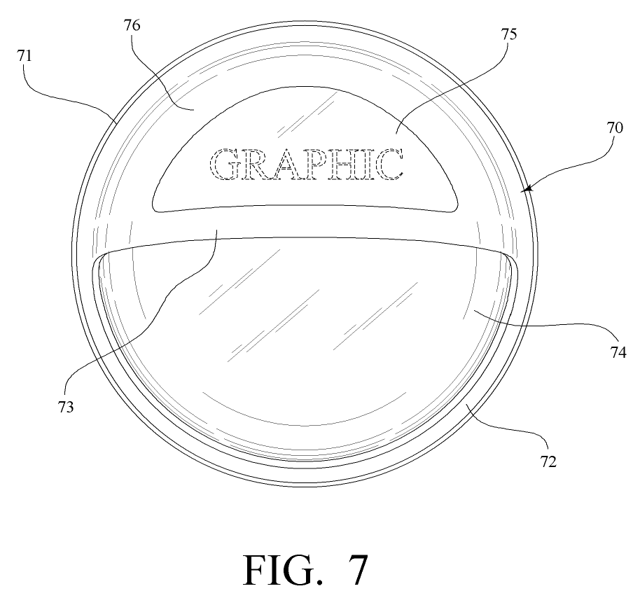

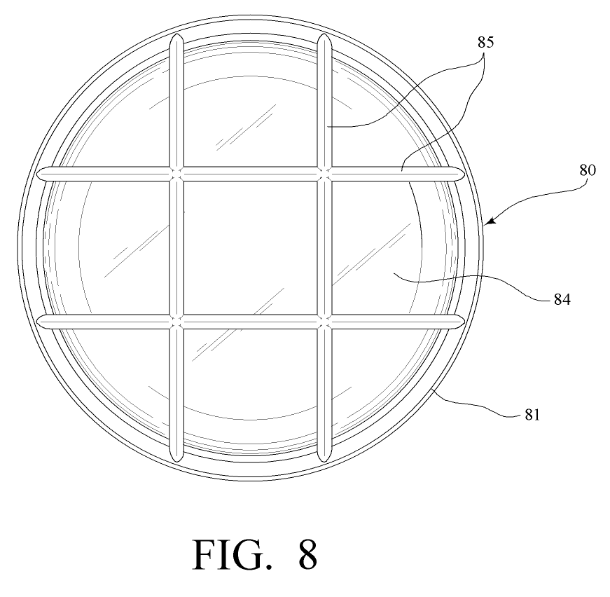

FIGS. 7 and 8 show alternative fronts on a front trim ring. In FIG. 7, front trim ring 70 is an open eyelid cover having annular side wall 71 in a substantially bezel configuration. Extending inward from annular side wall 71 is a graphical display divider 73 separating the illumination of a lamp contained therein into two distinct areas. A graphical display area 75 is provided about the lens and is defined with graphical outer trim 76 and graphical display divider 73 and forms the open eyelid. Graphical outer trim 76 depends inward from annular side wall 71 defining the outer perimeter of graphical display area 75. Graphical display area 75 can incorporate any type of graphical overlay, preferably transparent or translucent, such as a logo, an illuminated scene, or even an advertisement. The other area defined by graphical display divider 73 is illumination area 74 which has outer trim 72 extending inward from annular side wall 71 defining the outer perimeter of illumination area 74. FIG. 8 shows vandal resistant luminaire 80 having a grid pattern about lens 84. The grid pattern is formed with cross members 85 extending inward from annular side wall 81. Luminaires 70 and 80 provide examples of embodiments of alternative lens covering portions of the front trim ring, persons having ordinary skill in the art may provide yet other embodiments without departing from the scope of the claims herein as such will become evident upon reading this disclosure.

A vandal resistant luminaire is provided herein for improving the resilience and aesthetics of the luminaire. The optional rear trim ring circumscribes a rear portion of an electrical component housing forming a flush mount of the luminaire eliminating pry points. An annular space between the rear trim ring and housing allows for deformation of the rear trim ring upon the application of a physical shock thereto thus absorbing a portion of the force protecting the luminaire. Optionally, this annular space may be filled with a shock absorbing material such as a rubber or foam such as neoprene. A gasket having a sealing and shock absorbing configuration is mounted between a lens and the electrical component housing. A front trim ring removeably locks onto a front portion of the electrical component housing sealing the lens to the electrical component housing. The front trim ring preferably has a bezel configuration and optionally forms a design about or forms a graphical display area on the lens.

We claim:

1. A vandal resistant luminaire comprising:
an electrical component housing having an outwardly extending rim separating a front portion from a rear portion, said front portion having a front opening with a front edge thereabout, said front edge being a gasket ring suitable for receiving a gasket, at least one lamp socket, wiring, and associated electrical components contained therein;
a gasket mounted on said gasket ring;
a lens with a rear circumferential surface sealed against said gasket; and
a front trim ring surrounding an outer portion of said lens and an outer portion of said front portion of said electrical component housing and bearing against said lens to hold it in a sealing position adjacent said gasket.

2. The vandal resistant luminaire of claim 1 having a rear trim ring surrounding said rear portion of said electrical component housing, said rear trim ring having a shock absorbing configuration protecting said vandal resistant luminaire from physical shock placed thereto, said rear trim ring having a substantially flat rear mating edge and a front surface configured to mount substantially flush with a rear surface of said outwardly extending rim on said electrical component housing substantially eliminating pry points between said electrical component housing and a surface to which it is mounted.

3. The vandal resistant luminaire of claim 2 wherein said rear trim ring has a rear opening with a larger radius than a front opening forming an annular space between said rear trim ring and said electrical component housing.

4. The vandal resistant luminaire of claim 3 wherein said annular space is filled with a shock absorbing material.

5. The vandal resistant luminaire of claim 4 wherein said annular space is filled with neoprene.

6. The vandal resistant luminaire of claim 1 wherein said front trim ring has at least two inwardly extending twist locks that cooperate with retaining legs on an outer surface of said front portion of said electrical component housing thereby enabling said front trim ring to removeably hold said lens adjacent said gasket.

7. The vandal resistant luminaire of claim 6 wherein said front trim ring has a portion extending about a front surface of said lens.

8. The vandal resistant luminaire of claim 8 wherein said portion of said front trim ring extending about a front surface thereof forms a graphical display area about said lens.

9. The vandal resistant luminaire of claim 1 wherein said gasket has an expanded sealing configuration with a hollow core and a compressed physical shock absorbing configuration suitable for protecting said vandal resistant luminaire from environmental elements and physical shock placed on said lens.

10. The vandal resistant luminaire of claim 9 wherein said gasket has a raised thickened portion adjacent said gasket ring and an upper portion suitable for folding inwardly when a physical shock is placed on said lens providing a plurality of layers of material forming said gasket between said lens and said gasket ring.

11. A vandal resistant luminaire comprising:
an electrical component housing having at least one lamp socket and associated wiring contained therein, said electrical component housing having a substantially round cross sectional side wall with an outwardly extending rim proximate a front opening, and a substantially disk shaped rear wall;
a dome shaped lens about said front opening;
a gasket disposed between said lens and said rim of said electrical component housing wherein said gasket is disposed about a front edge of said housing circumscribing said front opening;
said gasket having an front cross-sectional portion with a hollow core and a receiving notch in a rear cross-sectional portion receiving said front edge of said housing; and
a front trim ring surrounding proximate portions of said electrical component housing and said lens, said front trim ring having twist locks extending from an inner annular surface twistingly engaging a plurality of retaining legs extending from an outer surface of said electrical component housing and removeably holding a rear edge of said front trim ring adjacent said outwardly extending rim.

12. The vandal resistant luminaire of claim 11 having a rear trim ring with a rear opening substantially in a plane with said disk shaped rear wall of said rear portion of said electrical component housing and a front edge substantially adjacent an inner surface of said outwardly extending rim.

13. The vandal resistant luminaire of claim 12 wherein said rear trim ring has a side wall of a larger radius than said side wall of said electrical component housing forming a void between a said electrical component housing and said rear trim ring making said rear trim ring able to deform when a physical force is placed thereon.

14. The vandal resistant luminaire of claim 13 wherein said void is filled with a shock absorbing material.

15. The vandal resistant luminaire of claim 12 wherein said side wall of said rear trim ring has shock absorbing ribs extending from an inner surface thereof.

16. The front trim ring of claim 11 having a locking aperture receiving a portion of a fastener cooperating with said side wall of said electrical component housing.

17. The front trim ring of claim 11 having a front portion extending about said lens forming a graphical display area thereon.

18. A vandal resistant luminaire with an electrical component housing having wiring and at least one lamp socket contained therein, a sealing and shock absorbing gasket mounted about a front opening, a lens removeably held proximate said electrical component housing adjacent said gasket with a front trim ring surrounding an outer portion of said lens and having twist locks on an inner surface cooperating with retaining legs on an outer surface of said electrical component housing.

19. The vandal resistant luminaire of claim 18 wherein said electrical component housing, said gasket, and said front trim ring have round cross-sectional configurations.

20. The vandal resistant luminaire of claim 18 further having a rear trim ring covering a rear portion of said electrical component housing with a void space there between, said rear trim ring being formed of a material suitable for absorbing a physical shock.

21. The vandal resistant luminaire of claim 20 wherein said void space is filled with a shock absorbing material.

22. A vandal resistant luminaire with an electrical component housing having wiring and at least one lamp socket contained therein, a gasket suitable for sealing and absorbing physical shock mounted on a front edge, a lens removeably held adjacent said gasket with a front trim ring surrounding an outer portion of said lens, said front trim ring forming a graphical display area about said lens wherein said graphical display area is suitable to receive graphical inserts.
